(19) United States
(12) Patent Application Publication
(10) Pub. No.: US 2007/0217225 A1
(43) Pub. Date: Sep. 20, 2007

(54) Light guide plate and backlight module using the same

(75) Inventor: Wen-Feng Cheng, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/521,943

(22) Filed: Sep. 15, 2006

(30) Foreign Application Priority Data
Mar. 17, 2006 (TW) 095109260

(51) Int. Cl. F21V 7/04

(52) U.S. Cl. 362/615

(57) ABSTRACT

A light guide plate includes an emitting surface; a reflective surface opposite to the emitting surface; an incident surface interconnecting with the emitting surface and the reflective surface. A plurality of ridges are formed on the reflective surface. Each ridge has a first base angle and a second base with respect to the reflective surface. The first base angle closest to the incident surface is in a range from about 86 degrees to 90 degrees. The second base angle furthest from the incident surface is in a range from about 41.8 degrees to 45.8 degrees. A backlight module using the light guide plate is also provided. The present light guide plate and a backlight module using the same can efficiently increase light brightness.

### BACKGROUND OF THE INVENTION

1. Field of the Invention

The present invention relates to light guide plates and backlight modules, particularly, to an edge-lighting type backlight module for use in, for example, a liquid crystal display (LCD).

2. Discussion of the Relate Art

In a liquid crystal display device, the liquid crystal is a substance that does not itself illuminate light. Instead, the liquid crystal relies on receiving light from a light source in order to display images and data. In a typical liquid crystal display device, a backlight module powered by electricity supplies the needed light.

Referring to FIG. 8, a typical backlight module 10 includes a light guide plate 12, a light source 18, and a plurality of optical correcting elements. The light guide plate 12 includes an incident surface 122 adjacent to the light source 18, an emitting surface 124 located at the top surface of the light guide plate 12 and adjacent to the incident surface 122, and a reflecting surface 126 opposite to the emitting surface 124. The optical correcting elements include a reflective sheet 11 positioned under the reflecting surface 126 for reflecting light back into the light guide plate 12, a diffusion sheet 13 positioned above the emitting surface 124 for diffusing emitted light and thereby avoiding a plurality of bright sections in the light guide plate 12, and a brightness enhancement sheet 14 positioned above the diffusion sheet 13 for collimating the emitted light beams uniformly to improve the light brightness. However, the optical correcting elements make the backlight module quite complicated and costly to manufacture.

The light guide plate 12 converts the light source 18 into a surface light source, and is one of the key components of the backlight module. Generally, the light guide plate 12 does not have a function of controlling the direction of light emitted therefrom. When the light source 18 emits a light 182, the light guide plate 12 receives the light 182 via the incident surface 122, reflects the light 182 at the reflecting surface 126, and emits the light 182 from the emitting surface 124 in an oblique direction away the light source 10. The angle of emission is not in a direction perpendicular to the emitting surface 124. Therefore a plurality of optical correcting elements needs to be added to and matched with the light guide plate 12, for improving the light brightness and optical uniformity of the backlight module 10.

Another typical backlight module 20 which can improve the light brightness by controlling the light emitting angle is shown as FIG. 9. The backlight module 20 includes a light source 21, a light guide plate 22 having an incident surface 221, and a transparent reflecting means 24 in optical contact with the light guide plate 22. The reflecting means 24 includes an optional adhesion promoting layer 246, and an array of micro-prisms 245 formed on the layer 246. Light reflects through the light guide plate 22 via total internal reflection, enters the micro-prisms 245 by way of light input surfaces 241 thereof, reflects off sidewalls 242 of the micro-prisms 245, and exits the micro-prisms 245 through emitting surfaces 243 thereof as a spatially directed light source. However, the reflecting means 24 make the backlight module high rather complicated in structure and costly to manufacture. In particular, the light guide plate 22 is difficult to mass produce by way of mold injection technology.

What is needed, therefore, is a light guide plate and backlight module using the same that overcome the above mentioned shortcomings.

### SUMMARY

In one aspect, a light guide plate according to a preferred embodiment includes an emitting surface; a reflective surface opposite to the emitting surface; an incident surface interconnecting with the emitting surface and the reflective surface. A plurality of ridges are formed on the reflective surface. Each ridge has a first base angle and a second base with respect to the reflective surface. The first base angle closest to the incident surface is in a range from about 86 degrees to 90 degrees. The second base angle furthest from the incident surface is in a range from about 41.8 degrees to 45.8 degrees.

In another aspect, a backlight module according to another embodiment includes a light source and a light guide plate. The same light guide plate as described in the previous paragraph is employed in this embodiment. The light source is positioned adjacent to a light input surface of the light guide plate.

Other advantages and novel features will become more apparent from the following detailed description of the preferred embodiments, when taken in conjunction with the accompanying drawings.

### BRIEF DESCRIPTION OF THE DRAWINGS

Many aspects of the light guide plate and related backlight modules having the same can be better understood with reference to the following drawings. The components in the drawings are not necessarily drawn to scale, the emphasis instead being placed upon clearly illustrating the principles of the present devices. Moreover, in the drawings, like reference numerals designate corresponding parts throughout the several views.

FIG. 1 is a schematic, isometric view of a backlight module according to a first preferred embodiment, the backlight module having a light guide plate, the light guide plate having an emitting surface, a reflective surface, an incident surface, and a plurality of ridges formed on the reflective surface;

FIG. 2 is a schematic, cross-sectional view taken along a II-II line of FIG. 1 showing each ridge having a first base angle θ₁ and a second base angle θ₂ with respect to the reflective surface;

FIG. 3 is a graph showing luminance intensity from the light guide plate at different angles perpendicular to the incident surface of four backlight module prototypes, three of which are present backlight module samples of FIG. 1 and the other of which is a conventional backlight module, the light guide plate of the conventional backlight module having no V-shaped protrusions.

FIG. 4 is a graph showing luminance intensity from the light guide plate at different angles parallel to the incident surface of four backlight module samples which are the same of FIG.3;

FIG. 5 is a graph showing luminance intensity from the light guide plate at different angles perpendicular to the incident surface of four backlight module samples, three of which are other present backlight module samples of FIG. 1 and the other of which is a conventional backlight module, the light guide plate of the conventional backlight module having no V-shaped protrusions;

FIG. 6 is a graph showing luminance intensity from the light guide plate at different angles parallel to the incident surface of four backlight module samples which are the same of FIG.5;

FIG. 7 is a schematic, isometric view of a backlight module according to a second preferred embodiment;

FIG. 8 a schematic, cross-sectional view of a conventional backlight module; and

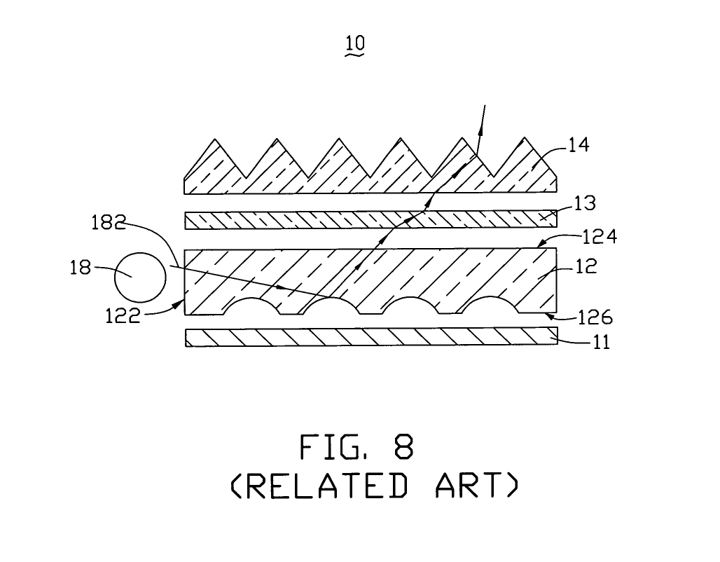

FIG. 9 is schematic, cross-sectional view of another conventional backlight module.

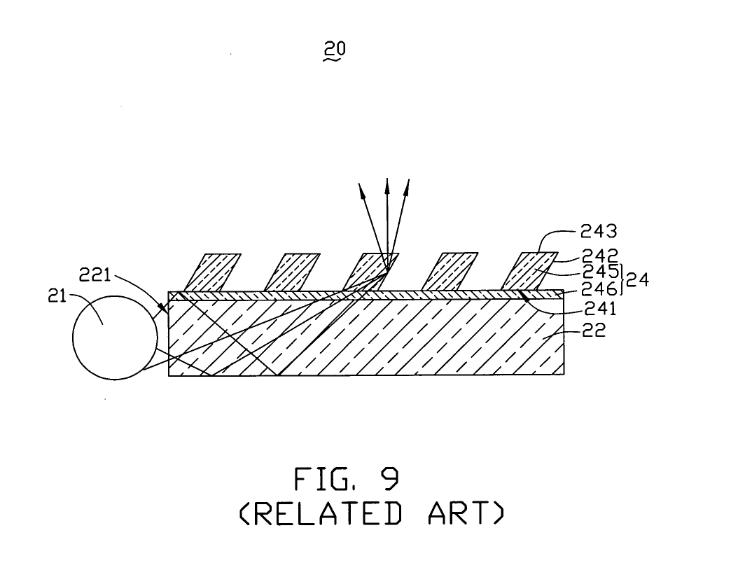

### DETAILED DESCRIPTION OF THE PREFERRED EMBODIMENTS

Reference will now be made to the drawings to describe preferred embodiments of the present light guide plate and backlight module using the same, in detail.

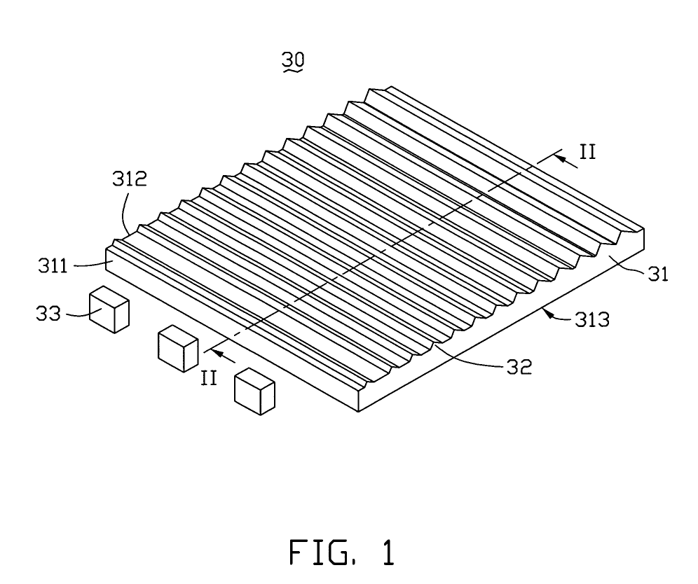

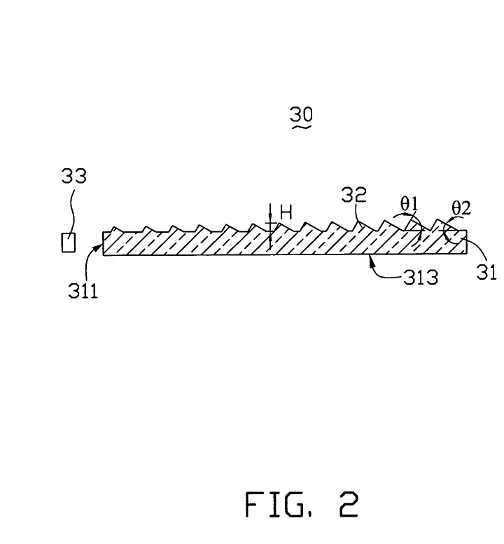

Referring to FIGS. 1 and 2, a backlight module 30 in accordance with a first preferred embodiment is shown. The backlight module 30 includes a plurality of light emitting diodes 33 (LED) and a light guide plate 31. The light guide plate 31 is a rectangular sheet, or alternatively may be generally cuneiform. In the illustrated embodiment, the light guide plate 31 is a rectangular sheet. The light guide plate 31 includes an emitting surface 313, a reflective surface 312 positioned opposite to the emitting surface 313, an incident surface 311 interconnecting the emitting surface 313 and the reflective surface 312, and a plurality of ridges 32 formed on the reflective surface 312. The LEDs 33 are aligned adjacent to the incident surface 311 of the light guide plate 31.

In this embodiment, each ridge 32 extends out from the reflective surface 312 along a direction parallel to the incident surface 311. The ridges 32 are configured to be aligned parallel (or at least essentially parallel) to each other. The ridges 32 are similar in shape with each other, but are different in size. Each of the ridges 32 has a triangular cross-section. The triangular cross-section includes a first base angle θ1 closest to the incident surface 311 and a second base angle θ2 furthest from the incident surface 311. The first base angle θ1 is configured to be about in the range from about 86 degrees to about 90 degrees. The second base angle θ2 is configured to be in the approximate range from about 41.8 degrees to about 45.8 degrees.

The ridges 32 are disposed in an uneven distribution density. The distribution density and a relative size thereof progressively increases with increasing distance from the incident surface 311, in other words, a distance between adjacent ridges 32 decreases with increasing distance from the incident surface 311. Heights H of the ridges 32 are configured to be in the range from 0.001 millimeters to about 0.02 millimeters.

Light rays are projected from the LEDs 33 onto the incident surface 311 of the light guide plate 31. The light guide plate 31 refracts and reflects the light rays at the ridges 32 of the reflective surface 312 thereof, the light rays then exits out from the emitting surface 313 of the light guide plate 31. By varying the two base angles θ1 and θ2 of the triangular cross-section of each ridge 32, the light brightness of the backlight module 30 can be controlled. It is to be understood that the ridges 32 may be selectively configured to be either of contiguous and discrete in a direction parallel to the incident surface 311. In this embodiment, the ridges 52 are contiguous.

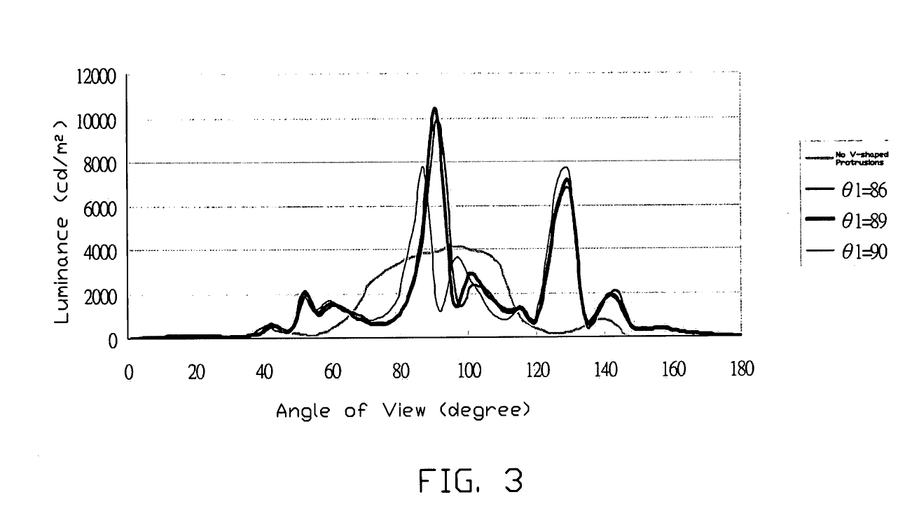

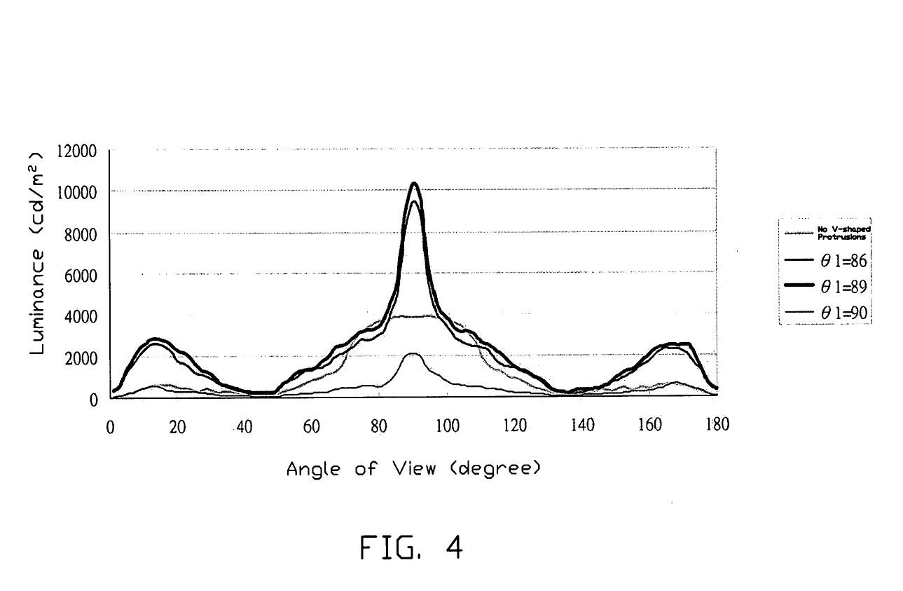

Referring to FIGS. 3 and 4, in order to test whether the ridges 32 can effectively improve the light brightness of the backlight module 30, four prototypes are prepared. The four prototypes, overall, include one conventional backlight module prototypes without ridges and three backlight module prototypes, as per the present embodiment, having the ridges. In the three prototypes having ridges, the second base angle θ2 of each ridge of the three prototypes is configured to be 43.8 degrees and the first base angle θ1 of each ridge of the three prototypes are respectively configured to be 86 degrees, 89 degrees, and 90 degrees.

FIG. 3 shows luminance intensity from the light guide plate at different angles perpendicular to the incident surface of a light guide plate of each prototype (i.e., the angles are defined from an axis on the light guide plate perpendicular to the incident surface with respect to a normal of the of the light guide plate). FIG. 4 shows luminance intensity from the light guide plate at different angles parallel to the incident surface of each prototype (i.e., the angles are defined from an axis on the light guide plate parallel to the incident surface with respect to a normal of the of the light guide plate). It can be concluded that the three prototypes having ridges have a relatively high luminance in most of viewing angles compared to the prototype without ridges from the FIGS. 3 and 4.

TAB. 1 shows testing results of five prototypes having ridges and a prototype without ridge. In the five prototypes having ridges, the second base angle θ2 of each ridge is configured to be 43.8 degrees and the first base angle θ1 is respectively selected from 86 degrees, 87 degrees, 88 degrees, 89 degrees, and 98 degrees. Values of luminance of the six backlight module samples are measured at the center of the emitting surface and around the perpendicular direction with respect to the emitting surface (the position at 90 degrees from the emitting surface thereof).

TABLE 1
testing results of the backlight module samples

| | θ2 = 43.8 degrees | | | | | |
|---|---|---|---|---|---|---|
| | θ1 = 86 | θ1 = 87 | θ1 = 88 | θ1 = 89 | θ1 = 90 | |
| Sample | degrees | degrees | degrees | degrees | degrees | No ridges |
| Luminance | 9007 | 9281 | 9962 | 10187 | 2725 | 3868 |
| (cd/m²) | | | | | | |

By analyzing the testing results shown in TAB. 1, it can be concluded that the values of luminance of four prototype having ridges (θ1=86 degrees, 87 degrees, 88 degrees, and 89 degrees; θ2=43.8 degrees) are much higher than that of the prototype without ridges. The value of luminance of the prototype with θ1=89 degrees and θ2=43.8 degrees is highest. It is noted that the θ1 is configured to be closed to 90 degrees, the value of luminance is higher than that of conventional backlight module prototypes without ridges.

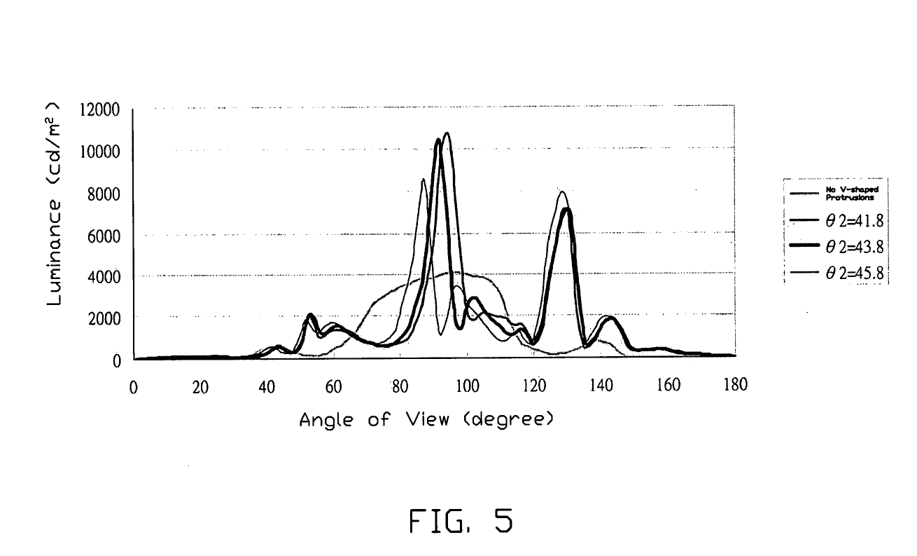

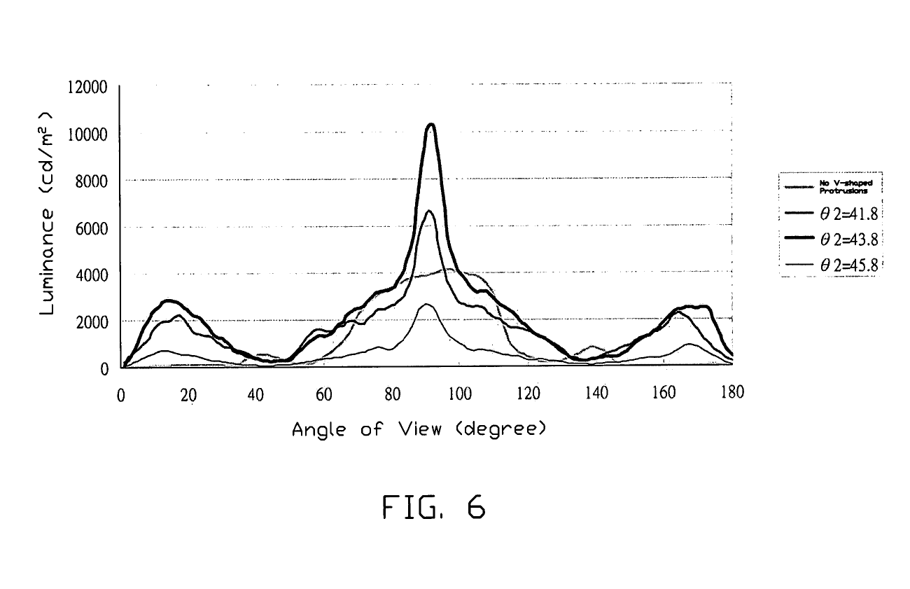

In the same way, referring to FIGS. 5 and 6, in order to test whether the ridges 32 can effectively improve the light brightness of the backlight module 30, anther four prototypes is prepared. The four prototypes, overall, included one conventional backlight module prototypes without ridges and three backlight module prototypes, as per the present embodiment, having the ridges. Of the three prototypes having ridges, the first base angle θ1 of each ridge of the three prototypes is configured to be 89 degrees and the second base angle θ2 of each ridge of the three prototypes are respectively selected from 41.8 degrees, 43.8 degrees and 45.8 degrees.

FIG. 5 shows luminance intensity from the light guide plate at different angles perpendicular to the incident surface of each prototype. FIG. 6 shows luminance intensity from the light guide plate at different angles parallel to the incident surface of a light guide plate of each prototype. It can be concluded that the two prototypes (θ1=89 degrees; θ2=41.8 degrees, or 43.8 degrees) having ridges have a relatively higher luminance in most of viewing angles compared to the prototype without ridges from the FIGS. 5 and 6.

TAB. 2 shows the testing results of five prototypes having ridges and a prototype without ridge. Of the five prototypes having ridges, the first base angle θ1 of each ridge 32 is configured to be 89 degrees and the second base angle θ2 is respectively selected from 41.8 degrees, 42.8 degrees, 43.8 degrees, 44.8 degrees and 45.8 degrees. The values of luminance of above six backlight module samples are measured at the center of the emitting surface and around the perpendicular direction with respect to the emitting surface (the position at 90 degrees from the emitting surface thereof).

TABLE 2
testing results of the backlight module samples

| | θ1 = 89 degrees | | | | | |
|---|---|---|---|---|---|---|
| | θ2 = | θ2 = | θ2 = | θ2 = | θ2 = | |
| | 41.8 | 42.8 | 43.8 | 44.8 | 45.8 | |
| Sample | degrees | degrees | degrees | degrees | degrees | No ridges |
| Luminance | 6429 | 7870 | 10187 | 8492 | 3490 | 3868 |
| (cd/m²) | | | | | | |

By analyzing the testing results shown in TAB. 2, it can be concluded that luminances of the four prototypes having ridges with θ1=89 degrees; and θ2=41.8 degrees, 42.8 degrees, 43.8 degrees, and 44.8 degrees are much higher than that of the prototype without ridges. The value of luminance of the prototype with θ1=89 degrees and θ2=43.8 degrees is highest. It is noted that when the θ2 is configured to be around 45.8 degrees, the value of luminance is substantially higher than that of the conventional backlight module prototypes without ridges.

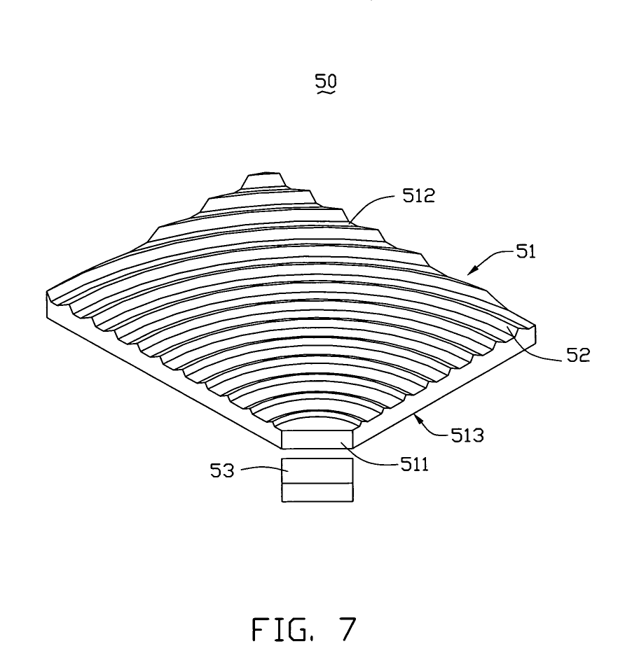

Referring to FIG. 7, a backlight module 50 in accordance with a second preferred embodiment is shown. The backlight module 50 in accordance with the second preferred embodiment is the same as the backlight module 30 of the first embodiment, except that an incident surface 511 of a light guide plate 51 is defined at a cut-out portion of the light guide plate 51 extending from a corner of an emitting surface 513 to a corresponding corner of a reflective surface 512. In addition, a light source 53 is a point light source such as an LED disposed at a side of the incident surface 511 facing the incident surface 511. Furthermore, a plurality of ridges 52 are arranged on the reflecting surface 512 along a plurality of imaginary concentric circular arcs, such arcs centering on a reference point that is located adjacent the incident surface. In this embodiment, the reference point is located at the light source 53.

Each of the ridges 52 has a triangular cross-section, when viewed along the diagonal line that passing through the reference point. The triangular cross-section includes a first base angle closest to the incident surface 511 and a second base angle furthest from the incident surface 511. The first base angle is configured to be about in the range from about 86 degrees to about 90 degrees. The second base angle is configured to be in the approximate range from about 41.8 degrees to about 45.8 degrees. The ridges 52 are disposed in an uneven distribution density. The distribution density and a relative size thereof progressively increases with increasing distance from the incident surface 511, and respective distances between adjacent second ridges 52 decreases with increasing distance from the incident surface 511.

It is to be understood that the ridges 52 are selectively configured to be one of contiguous and discrete within a given imaginary arc. In this embodiment, the ridges 52 are contiguous.

The light guide plate may be comprised of a material selected from polymethyl methacrylate (PMMA), polycarbonate (PC), and other suitable transparent resin materials. It is to be understood that, in the first embodiment, at least one cold cathode fluorescent lamp (CCFL) may be replaced the light source 33. The present light guide plate may be integrally formed by injection molding technology.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

What is claimed is:

1. A light guide plate, comprising:
an emitting surface;
a reflective surface opposite to the emitting surface;
an incident surface interconnecting with the emitting surface and the reflective surface; and
a plurality of ridges formed on the reflective surface, wherein each ridge has a first base angle and a second base with respect to the reflective surface, the first base angle closest to the incident surface being in a range from about 86 degrees to 90 degrees, and the second base angle furthest from the incident surface being in a range from about 41.8 degrees to 45.8 degrees.

2. The light guide plate according to claim 1, wherein each ridge extends out from the reflective surface along a direction parallel to the incident surface.

3. The light guide plate according to claim 2, wherein the ridges are similar in shape with each other, but are different in size, a distribution density and a relative size of the ridges progressively increasing with increasing distance from the incident surface, and respective distances between adjacent second ridges decreasing with increasing distance from the incident surface.

4. The light guide plate according to claim 2, wherein the ridges are selectively configured to be one of contiguous and discrete in a direction parallel to the incident surface.

5. The light guide plate according to claim 1, wherein the light guide plate is a flat sheet having a substantially rectangular shape from top view, the incident surface is disposed at a cut-out portion of the light guide plate extending from a corner of the emitting surface to a corresponding corner of the bottom surface, the ridges are arranged on the reflecting surface along a plurality of imaginary concentric circular arcs, such arcs centering on a reference point that is located adjacent the incident surface.

6. The light guide plate according to claim 5, wherein the ridges are similar in shape with each other, but are different in size, a distribution density and a relative size of the ridges progressively increasing with increasing distance from the incident surface, and respective distances between adjacent second ridges decreasing with increasing distance from the incident surface.

7. The light guide plate according to claim 5, wherein the ridges are selectively configured to be one of contiguous and discrete within a given imaginary arc.

8. The light guide plate according to claim 1, wherein heights of the ridges are in the range from 0.001 millimeters to about 0.02 millimeters.

9. The light guide plate according to claim 1, wherein the light guide plate is comprised of a material selected from polymethyl methacrylate, polycarbonate, and other suitable transparent resin materials.

10. A backlight module comprising:
a light source, and
a light guide plate having
an emitting surface;
a reflective surface opposite to the emitting surface;
an incident surface interconnecting with the emitting surface and the reflective surface, the light source being positioned adjacent to the incident surface; and
a plurality of ridges formed on the reflective surface, wherein each ridge has a first base angle and a second base with respect to the reflective surface, the first base angle closest to the incident surface being in a range from about 86 degrees to 90 degrees, and the second base angle furthest from the incident surface being in a range from about 41.8 degrees to 45.8 degrees.

11. The backlight module according to claim 10, wherein each ridge extends out from the reflective surface along a direction parallel to the incident surface.

12. The backlight module according to claim 11, wherein the ridges are similar in shape with each other, but are different in size, a distribution density and a relative size of the ridges progressively increasing with increasing distance from the incident surface, and respective distances between adjacent second ridges decreasing with increasing distance from the incident surface.

13. The backlight module according to claim 11, wherein the ridges are selectively configured to be one of contiguous and discrete in a direction parallel to the incident surface.

14. The backlight module according to claim 10, wherein the light guide plate is a flat sheet having a substantially rectangular shape from top view, the incident surface is disposed at a cut-out portion of the light guide plate extending from a corner of the emitting surface to a corresponding corner of the bottom surface, the ridges are arranged on the reflecting surface along a plurality of imaginary concentric circular arcs, such arcs centering on a reference point that is located adjacent the incident surface.

15. The backlight module according to claim 14, wherein the ridges have a similar shape but different sizes, a distribution density and a relative size of the ridges progressively increasing with increasing distance from the incident surface, and respective distances between adjacent second ridges decreasing with increasing distance from the incident surface.

16. The backlight module according to claim 14, wherein the ridges are selectively configured to be one of contiguous and discrete within a given imaginary arc.
